(19) United States
(12) Patent Application Publication
(10) Pub. No.: US 2011/0281568 A1
(43) Pub. Date: Nov. 17, 2011

(54) MANAGEMENT OF INCOMING TELEPHONY COMMUNICATIONS IN A LOCAL MEDIA NETWORK

(75) Inventor: Philippe Georges Le Clech, Lamorlaye (FR)

(73) Assignee: Rovi Technologies Corporation, Santa Clara, CA (US)

(21) Appl. No.: 12/779,548

(22) Filed: May 13, 2010

(51) Int. Cl. H04M 3/42; H04B 7/00

(52) U.S. Cl. 455/415; 455/41.2

(57) ABSTRACT

Systems and methods are provided for locally managing incoming telephony communication events on a user equipment display. In one embodiment, a user equipment device may include an input/output interface, a notification module, and a display device. The input/output interface may be configured to receive an indication of a communication event directed to a user telephony device over a short-range wireless connection. The notification module may be configured to generate a notification message in response to receiving the indication of a communication event. The indication of the communication event may include sender information, which may be included in the notification message. The display device may be configured to display the notification message so that it overlays a currently displayed video program.

### BACKGROUND OF THE DISCLOSURE

In recent years, some media service providers have offered systems that provide telephone call notification and management on a television interface. Many of these systems, however, are implemented on the service provider's equipment which gives the user little control over managing the notifications.

### SUMMARY OF THE DISCLOSURE

The present teachings relate to a system and method for locally managing incoming telephony communication events on a television display or other video consumption equipment. Some embodiments of the user equipment may include an input/output interface, a notification module, and a display device. The input/output interface may be configured to receive an indication of a communication event directed to a user telephony device over a short-range wireless connection. The notification module may be configured to generate a notification message in response to receiving the indication of a communication event. The indication of the communication event may include sender information, which may be included in the notification message. The display device may be configured to display the notification message so that it overlays a currently displayed video program.

Other embodiments relate to a method for operating a user equipment device. The method includes communicating with a user telephony device over a short-range wireless connection, receiving from the user telephony device an indication of a communication event, generating a notification message in response to receiving the indication of a communication event, and displaying the notification message on the user equipment, so that the notification message overlays a currently displayed video program. The indication of the communication event may include sender information and the sender information may be included in the notification message.

### BRIEF DESCRIPTION OF THE DRAWINGS

The above and other aspects and advantages of the invention will become more apparent upon consideration of the following detailed description, taken in conjunction with the accompanying drawings, in which like reference numerals refer to like parts throughout, and in which:

FIG. 1 shows an exemplary user equipment device according to the present teachings;

FIG. 2 is a simplified functional block diagram of an environment for practicing the present teachings;

FIG. 3 is a high-level flow chart of an exemplary method for operating user equipment according to the present teachings; and

FIG. 4 is an illustrative display of an exemplary notification message according to the present teachings.

### DETAILED DESCRIPTION OF EMBODIMENTS

The teachings described herein relate to a system and method for locally managing incoming telephony communication events on a user equipment display. One embodiment includes user television equipment coupled to a wireless user mobile device, such as a cellular phone, in a local network environment to receive and display notifications of communication events directed to the mobile device, such as incoming calls, short message service or enhanced message service (SMS/EMS) messages, and multimedia message service (MMS) messages. More particularly, the user equipment can be adapted to automatically discover one or more mobile devices through a short-range wireless link in order receive and display a notification message of incoming calls and text messages on a display associated with the user television equipment. Notification messages may be individualized for each mobile device and may be generated in accordance with predefined user profiles.

References throughout this document to “one embodiment,” “certain embodiments,” an embodiment,” “an implementation,” “an example” or similar terms means that a particular feature, structure, or characteristic described in connection with the example is included in at least one embodiment of the present teachings. Thus, the appearances of such phrases in various places throughout this specification are not necessarily all referring to the same embodiment. Furthermore, the particular features, structures, or characteristics may be combined in any suitable manner in one or more embodiments without limitation.

The use of the terms “include,” “includes,” “including,” “have,” “has,” or “having” should be generally understood as open-ended and non-limiting unless specifically stated otherwise. The use of the singular herein includes the plural (and vice versa) unless specifically stated otherwise. In addition, where the use of the term “about” is before a quantitative value, the present teachings also include the specific quantitative value itself, unless specifically stated otherwise.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Additionally, the accompanying figures are merely representative and may not be drawn to scale. Certain proportions thereof may be exaggerated, while others may be minimized. Accordingly, the specification and drawings are to be regarded as illustrative rather than a restrictive.

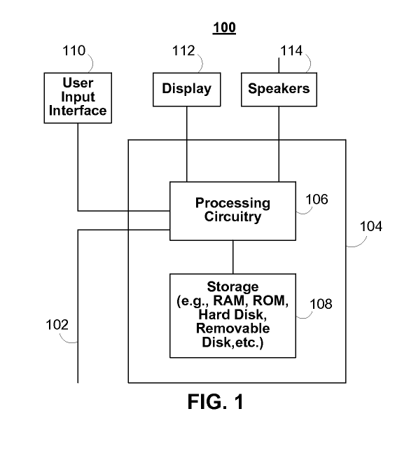

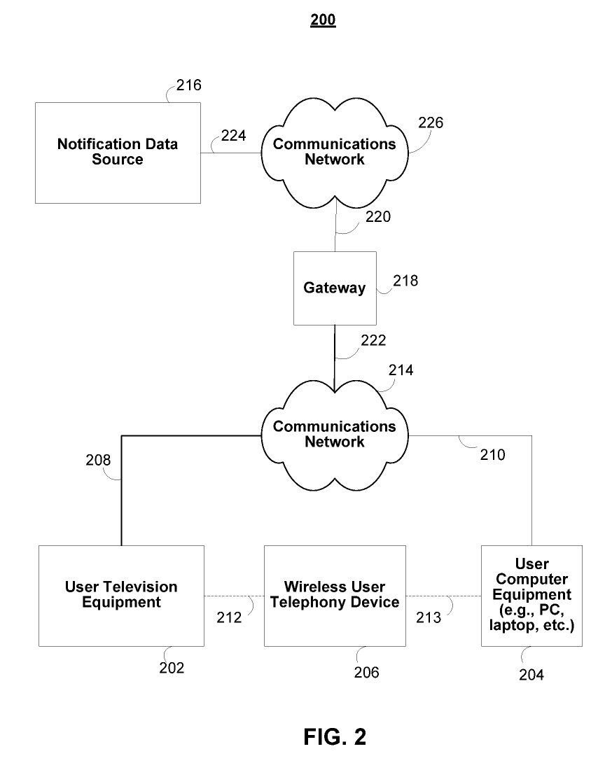

FIG. 1 shows a generalized embodiment of an illustrative user equipment device 100. More specific implementations of user equipment devices are discussed below in connection with FIG. 2. User equipment device 100 may receive via input/output (hereinafter “I/O”) path 102 an indication of a communication event directed to a user mobile device in the immediate vicinity. I/O path 102 may provide accompanying notification data (e.g., caller ID) to control circuitry 104, which includes processing circuitry 106 and storage 108. Control circuitry 104 may be used to send and receive commands, requests, and other suitable data using I/O path 102. I/O path 102 may connect control circuitry 104 (and specifically processing circuitry 106) to one or more communications paths (described below). I/O functions may be provided by one or more of these communications paths, but are shown as a single path in FIG. 1 to avoid overcomplicating the drawing.

Control circuitry 104 may be based on any suitable processing circuitry 106 such as processing circuitry based on one or more microprocessors, microcontrollers, digital signal processors, programmable logic devices, etc. In some embodiments, control circuitry 104 executes instructions for a notification application stored in memory (i.e., storage 108). Communications circuitry may include a cable modem, an integrated services digital network (ISDN) modem, a digital subscriber line (DSL) modem, a telephone modem, or a wireless modem for communications with other equipment. Such communications may involve the Internet or any other suitable communications networks or paths (which is described in more detail in connection with FIG. 2). In addition, communications circuitry may include circuitry that enables support for short-range or long-range wireless access technologies.

Memory (e.g., random-access memory, read-only memory, or any other suitable memory), hard drives, optical drives, or any other suitable fixed or removable storage devices (e.g., DVD recorder, CD recorder, video cassette recorder, or other suitable recording device) may be provided as storage 108 that is part of control circuitry 104. Storage 108 may include one or more of the above types of storage devices. For example, user equipment device 100 may include a hard drive for a DVR (sometimes called a personal video recorder, or PVR) and a DVD recorder as a secondary storage device. Storage 108 may be used to store various types of data described herein, including user preferences or profile information, or other data used in operating the notification application. Nonvolatile memory may also be used (e.g., to launch a boot-up routine and other instructions).

A user may control the control circuitry 104 using user input interface 110. User input interface 110 may be any suitable user interface, such as a remote control, mouse, trackball, keypad, keyboard, touch screen, touch pad, stylus input, joystick, voice recognition interface, or other user input interfaces. Display 112 may be provided as a stand-alone device or integrated with other elements of user equipment device 100. Display 112 may be one or more of a monitor, a television, a liquid crystal display (LCD) for a mobile device, or any other suitable equipment for displaying visual images. In some embodiments, display 112 may be HDTV-capable. Speakers 114 may be provided as integrated with other elements of user equipment device 100 or may be stand-alone units. The audio component of videos and other media content displayed on display 112 may be played through speakers 114. In some embodiments, the audio may be distributed to a receiver (not shown), which processes and outputs the audio via speakers 114.

The notification application may be implemented using any suitable architecture. For example, it may be a stand-alone application wholly implemented on user equipment device 100. In such an approach, instructions of the application are stored locally and updates may be downloaded on a periodic basis. In yet other embodiments, the notification application is downloaded and interpreted or otherwise run by an interpreter or virtual machine (run by control circuitry 104). In other embodiments, the notification application may be defined by a series of JAVA-based files that are received and run by a local virtual machine or other suitable middleware executed by control circuitry 104.

User equipment device 100 of FIG. 1 can be implemented in system 200 of FIG. 2 as user television equipment 202, user computer equipment 204 or any other type of user equipment suitable for receiving and displaying communication event notifications. For simplicity, these devices may be referred to herein collectively as user equipment or user equipment devices. User equipment devices, on which a notification application is implemented, may function as a standalone device or may be part of a network of devices. Various network configurations of devices may be implemented and are discussed in more detail below.

User television equipment 202 may include a set-top box, an integrated receiver decoder (IRD) for handling satellite television, a television set, a digital storage device, a DVD recorder, a video-cassette recorder (VCR), a local media server, or other user television equipment. One or more of these devices may be integrated to be a single device, if desired. User computer equipment 204 may include a PC, a laptop, a tablet, a WebTV box, a personal computer television (PC/TV), a PC media server, a PC media center, or other user computer equipment. WEBTV is a trademark owned by Microsoft Corp.

Wireless user communications device 206 may include PDAs, a mobile telephone, a portable video player, a portable music player, a portable gaming machine, or other wireless devices capable of receiving and transmitting indications of communication events.

It should be noted that with the advent of television tuner cards for PC's, WebTV, and the integration of video into other user equipment devices, the lines have become blurred when trying to classify a device as one of the above devices. In fact, each of user television equipment 202 and user computer equipment 204 may utilize at least some of the system features described above in connection with FIG. 1. and, as a result, include flexibility with respect to the type of media content available on the device. For example, user television equipment 202 may be Internet-enabled allowing for access to Internet content, while user computer equipment 204 may include a tuner allowing for access to television programming.

In system 200, there is typically more than one of each type of user equipment device but only one of each is shown in FIG. 2 to avoid overcomplicating the drawing. In addition, each user may utilize more than one type of user equipment device (e.g., a user may have a television set and a computer) and also more than one of each type of user equipment device (e.g., a user may have a computer and/or multiple television sets).

The user may also set various settings to maintain consistent notifications across user equipment devices. Therefore, changes made on one user equipment device can change the notification experience on another user equipment device, regardless of whether they are the same or a different type of user equipment device. In addition, the changes made may be based on settings input by a user, as well as user activity monitored by the notification application (i.e., learned settings). The different types of user profile settings are discussed below.

The user equipment devices may be coupled to communications network 214. Namely, user television equipment 202 and user computer equipment 204 are coupled to communications network 214 via communications paths 208 and 210, respectively. Communications network 214 may be one or more networks including a local area network or home network. Paths 208 and 210 may separately or together include one or more communications paths, such as free-space connections (e.g., for broadcast or other wireless signals) or any other suitable wired or wireless communications path or combination of such paths.

User mobile telephony device 206 may be coupled to user television equipment 202 and user computer equipment 204 via paths 212 and 213, as shown. Paths 212 and 213 are drawn with a dotted line to indicate that in the exemplary embodiment shown in FIG. 2 it is a wireless path and paths 208 and 210 are drawn as solid lines to indicate they are wired paths (although these paths may be wireless paths, if desired). User mobile telephony device 206 may communicate with user equipment devices using short-range point-to-point communication.

User equipment device 100 and user telephony device 206 may be configured to operate within a local network structure according to a set of guidelines established by the Digital Living Network Alliance (DLNA) and/or that support one or more universal plug and play (UPnP) protocols or other local network protocols. DLNA and UPnP define an architecture for peer-to-peer network connectivity of intelligent appliances, wireless devices, and personal computers. The UPnP Device Architecture (UDA) is designed to support automatic discovery of compatible devices. In that regard, the user equipment can dynamically join a network, obtain an Internet Protocol (IP) address, convey its capabilities, and learn about the presence and capabilities of other devices. In order to facilitate an understanding of the present teachings, various aspects of the teachings may be described in the context of DLNA and UPnP. It will be appreciated, however, that the systems and methods described herein may be applicable in any system or application where ad-hoc data communications between devices such as consumer and mobile electronics is desired. For example, data transfer technologies, such as USB cables, IEEE 1394 cables, wireless paths (e.g., Bluetooth, infrared, IEEE 802-11x, etc.), or other short-range communication via wired or wireless paths may be used instead of DLNA or UPnP. BLUETOOTH is a certification mark owned by Bluetooth SIG, INC. The user equipment devices may also communicate with each other directly through an indirect path via communications network 214.

System 200 includes a notification data source 216 coupled to communications network 226 via communication path 224. Communications network 226 is, in turn, coupled to communications network 214 via gateway 218 and communication paths 220 and 222. Communications network 226 may be one or more wide area networks including the Internet. Gateway 218 may be a residential gateway or other network element that allows user equipment devices to communicate with communications network 226 (e.g., the Internet). Communications with notification data source 216 may be exchanged over one or more communications paths, but are shown as a paths 220, 222, and 224 in FIG. 2 to avoid overcomplicating the drawing. In addition, there may be more than one of notification data source 216, but only one is shown in FIG. 2 to avoid overcomplicating the drawing. The different types of notification data sources are discussed below.

Notification data source 216 may include supplemental sender information such as text, photos or other types of media associated with the sender of a communication. Such content may be harvested from third party servers including social networking sites, such as Facebook, MySpace or Flickr. Data transfer between the third party server and user equipment can be automatic without any user action or can alternatively require manual approval by a user. Notification data source 216 may include, for example, an avatar or other information associated with a particular sender. For example, if a sender, Tim, calls a user of the system described herein, Tim's avatar may be included in the notification message displayed on the user's television equipment. In some embodiments, Tim's avatar or other social network information may only be displayed to Tim's family and friends or other user-defined access groups.

Supplemental sender information from notification data source 216 may be provided to the user equipment devices using any suitable approach. Supplemental sender information may be provided to the user equipment with any suitable frequency (e.g., continuously, daily, a user-specified period of time, a system-specified period of time, in response to a request from user equipment, etc.). In some approaches, supplemental sender data from notification data source 216 may be provided to users' equipment using a client-server approach. For example, a notification application client residing on the user's equipment may initiate sessions with notification data source 216 to obtain notification data when needed.

Notification applications may be, for example, stand-alone applications implemented on user equipment devices. In other embodiments, notification applications may be client-server applications where only the client resides on the user equipment device. For example, notification applications may be implemented partially as a client application on control circuitry 104 of user equipment device 100 and partially on a remote server as a server application (e.g., notification data source 216). The notification data source 216 may transmit data for storage on the user equipment, which then generates the notification application displays based on instructions processed by control circuitry.

System 200 is intended to illustrate a number of approaches, or network configurations, by which user equipment devices and user telephony equipment may communicate with each other in a home or local network environment for the purpose of displaying notifications, on user equipment devices, of communication events received by user telephony equipment. The present teachings may be applied in any one or a subset of these approaches, or in a system employing other approaches for delivering such notifications. The following two approaches provide specific illustrations of the generalized example of FIG. 2.

In one approach, user telephony device 206 may communicate directly with user television equipment 202 via short-range peer-to-peer communication schemes describe above. For example, as shown in FIG. 2, user mobile telephony device 206 may communicate directly with user television equipment 202 and/or user computer equipment 204. In a second approach, not shown in FIG. 2, user equipment devices communicate with one another via indirect paths through communications network 214. Using either approach, one user mobile telephony device 206 can communicate with a plurality of user equipment devices (e.g., multicast).

Each of the multiple individuals in a single home may operate different user equipment devices on communications network 214. As a result, it may be desirable for various notification information or user profile settings to be communicated between the different user equipment devices. For example, it may be desirable for users to maintain consistent user profile settings on different user equipment devices within communications network 214. For example, a user may transmit user profile settings from user telephony device 206 to user television equipment 202 and user computer equipment 204. Data transfer between user equipment can be automatic without any user action or can alternatively require manual approval by a user.

User profile settings may be associated with the user's telephone number, or other identifier, and can include parameters that control any aspect of the user's notification experience. For example, user profile settings may include settings for individualized call screening, also known in the art as selective inbound call filtering. Such settings may include a status indicator which indicates a user's willingness or reluctance to receive incoming communication. The status indicator may be set manually or automatically based on, for example, time-of-day, frequency, type, learned user behavior, events, sender identity, and priority rating of the particular communications being received. User profile settings may also be used to control display preferences including the notification type, color, location, and duration of the notification message. In some embodiments, a user profile can be associated with multiple users, such as users associated with a residence or a business entity. The user profile can be imported in whole or in part from other user equipment devices or downloaded from a third party server.

In some embodiments, notification information and settings may be centrally maintained and configured using a web interface. The web interface can be accessed using a Uniform Resource Locator (URL) via user computer equipment 204, or via a television interface, using a remote control device. In one embodiment, user computer equipment 204 operates as a web server for providing portal services. The present teachings also contemplate distributed configurations in which user profile settings are stored on more than one user equipment device.

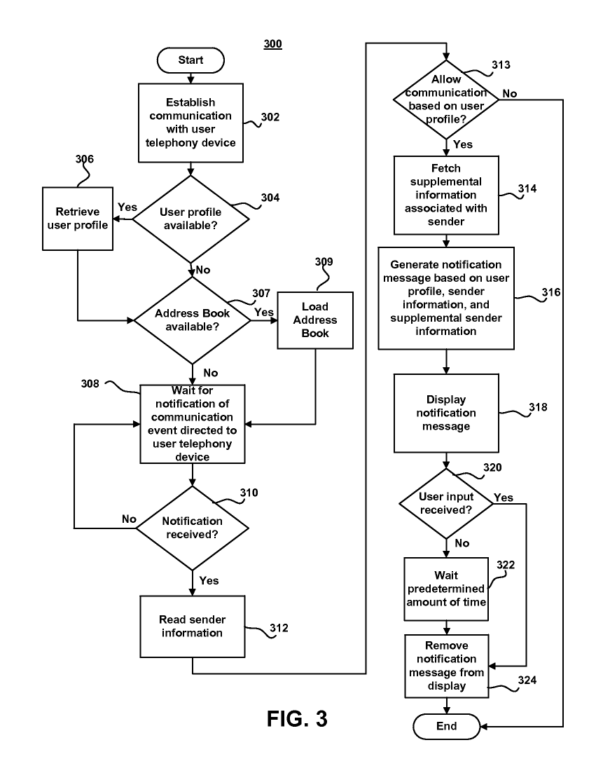

FIG. 3 is a high level flow chart of an exemplary method 300 of operating user equipment according to the present teachings. Method 300 begins in block 302 as user equipment (e.g., user television equipment 202) is coupled to a mobile device (e.g., user telephony device 206) using one or more of the above-described data communication schemes. In a DLNA home network, for example, coupling may include sending a DLNA search message to each of a plurality of DLNA-compliant telephony devices to discover active DLNA servers. If a user, Tim, walks into his living room with his mobile telephone in his pocket, the system can be configured to auto-discover Tim's phone. If multiple telephony devices are within the immediate vicinity of the user equipment, the system can provide notification services for each associated user based on their individual user profiles.

At block 304, the system determines whether the user associated with user mobile telephony device 206 has created a user profile. In some embodiments, the system uses an identifier associated with the mobile device (e.g., telephone number) to search a local storage device on the user equipment and/or a remote storage device. If a user profile exists, the system retrieves it at block 306 and proceeds to block 307.

At block 307, the system determines whether the user associated with the user mobile telephony device 206 has created an address book. In some embodiments, the system receives an address book from user mobile telephony device 206 and/or a network address book. The address book may be associated with a particular user or a group of users (e.g., household). If an address book exists, the system retrieves it at block 307 and proceeds to block 308.

At blocks 308 and 310, the system continuously monitors the communication path established at block 302 (e.g., path 212) for an indication of a communication event directed to the mobile device. If an indication is received at block 310, the method continues at block 312 and reads the associated sender information to identify the sender (e.g., caller ID). The address book received in block 307, if available, is then searched to find a record having sender identification information matching the sender identification information of the incoming communication.

At block 313, the system determines whether to display a notification message based on the user profile. If allowable, the system attempts to fetch supplemental sender information (e.g., photos, nicknames, avatars) from online sources, as described above at block 314. At block 316, the system generates a notification message based on the user profile, sender information, and supplemental sender information.

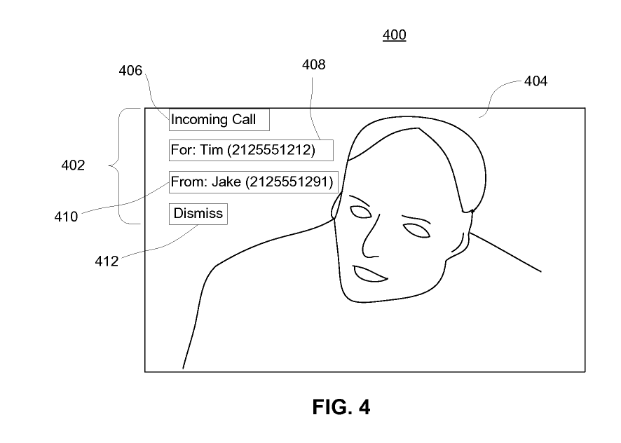

At block 318, the notification message is displayed on the user equipment (e.g., user television equipment 202). The notification message can include any combination of available content and format. FIG. 4 is an illustrative display 400 of an exemplary notification message 402 overlayed on video program 404. As shown, notification message 402 includes a communication type 406, a receiving party 408, a sending party 410, and a user prompt 412 so the user can respond to or dismiss the notification. In some embodiments the displayed notification message includes an audio notification. Unlike a notification message transmitted from a service provider's equipment, via a set-top box, the notification message will be displayed regardless of the video source (e.g., DVR, DVD) because the notification message is generated by user television equipment 202.

The notification message may display notifications for more than one user. For example, if more than one user telephony device is coupled to the user equipment, the notification message can identify the user telephony device to which the communication event was directed. If Tim's telephony device is coupled to the user equipment and Jake moves within the immediate vicinity of the user equipment with his telephony device, Jake's telephony device may be automatically coupled with the user equipment along with Tim's telephony device. In this arrangement, both Tim and Jake can be notified of incoming communication events directed to their respective telephony devices on the user equipment display. If, for example, Tim receives a funny MMS from a sender at another location, Tim can easily share the MMS with Jake by displaying the MMS on the user equipment display according to the present teachings.

The notification message may also be displayed having a format that can automatic or alternatively require manual user settings. The notification message may be displayed in any location, font, font size, or color. User television equipment may include an ambient light sensor for determining the level of ambient light and adjusting the brightness of the notification message accordingly. If the room is dark, the notification message may include a blue or green light illuminated on the television panel or display.

At block 320, if a predefined user input is received (e.g., exit key), the system removes the notification message from the display. Otherwise, at block 322, the system waits a predetermined amount of time before automatically removing the notification message from the display at block 324.

The flowchart and block diagrams in the figures illustrate the architecture, functionality, and operation of possible implementations of systems, methods and computer program products according to various embodiments of the present teachings. In this regard, each block in the flowchart or block diagrams may represent a module, segment, or portion of code, which may include one or more executable instructions for implementing the specified logical function(s). It should also be noted that the order of execution or performance of the methods illustrated and described herein is not essential, unless otherwise specified. That is, elements of the methods may be performed in any order, unless otherwise specified, and that the methods may include more or less elements than those disclosed herein. For example, it is contemplated that executing or performing a particular element before, contemporaneously with, or after another element is within the scope of the present teachings.

Although the present specification describes components and functions implemented in the embodiments with reference to particular standards and protocols, the disclosure is not limited to such standards and protocols. Each of the standards for peer-to-peer network transmission (e.g., Bluetooth, DLNA, UPnP) represent examples of the state of the art. Such standards are periodically superseded by faster or more efficient equivalents having essentially the same functions. Accordingly, replacement standards and protocols having the same functions are considered equivalents.

### OTHER EMBODIMENTS

The present teachings can be embodied in other specific forms, not delineated above, without departing from the spirit or essential characteristics thereof. The foregoing embodiments are therefore to be considered in all respects illustrative rather than limiting on the present teachings described herein. Scope of the present invention is thus indicated by the appended claims rather than by the foregoing description, and all changes that cone within the meaning and range of equivalency of the claims are intended to be embraced therein.

What is claimed is:

1. A method of operating user equipment comprising:
communicating with a user telephony device over a short-range wireless connection;
receiving from the user telephony device a indication of a communication event directed to the user telephony device, wherein the indication includes sender information associated with the communication event;
generating a notification message in response to receiving the indication of a communication event, wherein the notification message includes the sender information; and
displaying the notification message on the user equipment, wherein the notification message overlays a currently displayed video program.

2. The method of claim 1, wherein the connection is a peer-to-peer connection.

3. The method of claim 1, wherein the user telephony device and user equipment are uPNP or DLNA compliant devices.

4. The method of claim 1, wherein the user equipment is one of user television equipment or user computer equipment.

5. The method of claim 1, wherein the communication event is an SMS event and the notification message includes a text message.

6. The method of claim 1, wherein the communication event is an incoming call and the notification message includes caller ID information.

7. The method of claim 1, further comprising,
using the sender information to obtain a sender name associated with the sender information; and
including the sender name in the notification message.

8. The method of claim 1, further comprising,
using the sender information to obtain supplemental sender information associated with the sender information; and
including the supplemental sender information in the notification message.

9. The method of claim 1, further comprising,
using the sender information to obtain a photo associated with the sender information;
including the photo in the notification message.

10. The method of claim 1, wherein the notification message is customized based on a user profile.

11. The method of claim 1, wherein the currently displayed video program is received from a DVD player.

12. The method of claim 1, wherein the user telephony device is automatically discovered.

13. The method of claim 1, further comprising,
communicating with a second user telephony device over a second peer-to-peer connection; and
receiving from the second user telephony device an indication of a communication event directed to the second user telephony device.

14. The method of claim 1, further comprising receiving an instruction to remove the notification message from the display.

15. User television equipment comprising:
an input/output interface, the input/output interface being configured to receive an indication of a communication event directed to a user telephony device, the communication being received over a short-range wireless connection, the indication including sender information associated with the communication event;
a notification module, the notification module being configured to generate a notification message in response to receiving the indication of a communication event, wherein the notification message includes the sender information; and
a display device, the display device being configured to display the notification message, wherein the notification message overlays a currently displayed video program.

16. The user television equipment of claim 15, the input/output interface being configured to communicate with the user telephony device over a Bluetooth connection.

17. The user television equipment of claim 15, the input/output interface being configured to receive an address book from the user telephony device.

18. A computer program product for managing notifications of communication events in a home network environment, said computer program product comprising a computer usable medium having computer usable program instructions recorded thereon, said computer usable program instructions when loaded onto and executed by a computer causing the computer to perform a method comprising:
receiving from a user telephony device a indication of a communication event directed to the user telephony device, wherein the indication includes sender information associated with the communication event, and wherein the indication is received over a short-range wireless connection;
generating a notification message in response to receiving the indication of a communication event, wherein the notification message includes the sender information; and
displaying the notification message on the user television equipment, wherein the notification message overlays a currently displayed video program.
